(19) United States
(12) Patent Application Publication
(10) Pub. No.: US 2021/0350178 A1
(43) Pub. Date: Nov. 11, 2021

(54) INFORMATION PROCESSING DEVICE, INFORMATION PROCESSING METHOD, AND PROGRAM

(71) Applicant: Sony Corporation, Tokyo (JP)

(72) Inventors: Hikaru Ikuta, Tokyo (JP); Naoki Ide, Tokyo (JP); Kazuki Yoshiyama, Tokyo (JP)

(73) Assignee: Sony Corporation, Tokyo (JP)

(21) Appl. No.: 17/278,160

(22) PCT Filed: Sep. 13, 2019
(86) PCT No.: PCT/JP2019/036118

§ 371 Date: Mar. 19, 2021

(30) Foreign Application Priority Data
Sep. 27, 2018 (JP) 2018-181474

(51) Int. Cl. G06K 9/62; G06N 3/04

(52) U.S. Cl. CPC G06K 9/6257; G06K 9/6265; G06K 9/628; G06N 3/04

(57) ABSTRACT

It is aimed to facilitate obtaining of a large number of pieces of data for learning that are necessary to obtain a good-quality learning result.

A feature value of a first dataset is compared with feature values of a predetermined number of second datasets. A determination as to whether or not each of the predetermined number of second datasets is a dataset usable together with the first dataset is made on the basis of the result of the comparison. For example, the determination is made referring to lacking data information associated with the first dataset. For example, information regarding a second dataset having been determined to be the dataset usable together with the first dataset is presented.

### TECHNICAL FIELD

The present technology relates to an information processing device, an information processing method, and a program and, more particularly, to an information processing device and the like that deal with datasets for machine learning.

### BACKGROUND ART

Proposed are services which provide machine learning that is performed by a server on a network, for example. In this case, the server performs the machine learning on the basis of datasets regarding images, speeches, texts, and/or the like that are provided by a user. The machine learning needs a large number of pieces of data to obtain a good-quality learning result, but, in general, it is difficult for the user to collect such a large number of pieces of data all by him/herself. For example, PTL 1 describes a technique which increases the quality of data for learning, but it is difficult to collect a large number of pieces of such increased-quality data.

### CITATION LIST

### Patent Literature

### [PTL 1]

Japanese Patent Laid-open No. 2015-87903

### SUMMARY

### Technical Problem

An object of the present technology is to facilitate obtaining of a large number of pieces of data for learning that are necessary to obtain a good-quality learning result.

### Solution to Problem

The concept of the present technology lies in an information processing device including a control unit that controls comparison processing for comparing a feature value of a first dataset with feature values of a predetermined number of second datasets and determination processing for determining whether or not each of the predetermined number of second datasets is a dataset usable together with the first dataset, on the basis of the result of the comparison.

In the present technology, the comparison processing and the determination processing are controlled by the control unit. In the comparison processing, a feature value of the first dataset is compared with feature values of the predetermined number of second datasets. For example, a feature value of each of the first dataset and the second datasets may be configured to be an average or a standard deviation regarding aggregates of predetermined elements of output and intermediate layers in a learned neural network at times when individual sets of data constituting the dataset are input to the leaned neural network. Further, for example, the feature value of each of the first dataset and the second datasets may be configured to be, in the case where each of sets of data constituting the dataset has a label of a corresponding one of classes, a distribution of total numbers of data in the individual classes.

In the determination processing, a determination as to whether or not each of the predetermined number of second datasets is a dataset usable together with the first dataset is made on the basis of the result of the comparison. For example, the determination processing may be configured such that lacking data information associated with the first dataset is referred to. This configuration makes it possible to determine that a second dataset having data that may complement lacking data in the first dataset is the dataset usable together with the first dataset.

In such a way, the present technology is configured such that a feature value of the first dataset is compared with feature values of the predetermined number of second datasets and that a determination as to whether or not each of the predetermined number of second datasets is a dataset usable together with the first dataset is made on the basis of the result of the comparison. This configuration, therefore, makes it possible to facilitate obtaining of datasets usable together with the first dataset.

Here, in the present technology, for example, the control unit may be configured to further control presentation processing for presenting information regarding each of second datasets that is included in the predetermined number of second datasets and that has been determined to be the dataset usable together with the first dataset. In this case, for example, the information regarding each of the second datasets may be configured to include information regarding a dataset name used for dataset identification, information regarding a conformity score indicating conformity with the first dataset, and/or information regarding sample data. This configuration, for example, enables a user having the first dataset to receive presentation of information regarding each of the second datasets that has been determined to be the dataset usable together with the first dataset.

Further, for example, the presentation processing may be configured to further present a sorting order specification region for use in specifying in which order the information regarding each of the second datasets that has been determined to be the dataset usable together with the first dataset is to be presented. This configuration enables the user having the first dataset to cause the information regarding each of the second datasets that has been determined to be the dataset usable together with the first dataset to be presented in an appropriate order.

Further, for example, the presentation processing may be configured to further present a filtering information input region for use in inputting information for filtering one or more to-be-presented second datasets from the second datasets that have been determined to be the dataset usable together with the first dataset. This configuration enables the user having the first dataset to cause any one or more second datasets to be presented, from information regarding the second datasets that have been determined to be the dataset usable together with the first dataset.

Further, for example, the presentation processing may be configured to further present an operation region that is associated with the presented information regarding each of the second datasets and that is used for an operation that causes a detailed display of the each of the second datasets to be performed. This configuration enables the user having the first dataset to cause the details of each of the second datasets that has been determined to be the dataset usable together with the first dataset to be displayed.

### BRIEF DESCRIPTION OF DRAWINGS

FIG. 1 is a block diagram illustrating a configuration example of an information processing system as an embodiment.

FIG. 2 depicts diagrams illustrating an example of a use case of a second dataset to be used together with a first dataset.

FIG. 3 depicts diagrams illustrating another example of the use case of the second dataset to be used together with the first dataset.

FIG. 4 is a block diagram illustrating a configuration example of a user device.

FIG. 5 is a block diagram illustrating a configuration example of a cloud server.

FIG. 6 is a diagram that describes the outline of processing of the information processing system.

FIG. 7 is a diagram illustrating an example of an upload screen (1/3) displayed in a first user device.

FIG. 8 is a diagram illustrating an example of an upload screen (2/3) displayed in the first user device.

FIG. 9 is a diagram illustrating an example of an upload screen (3/3) displayed in the first user device.

FIG. 10 is a diagram illustrating an example of a search result display screen displayed in the first user device.

FIG. 11 is a diagram illustrating an example of a search result dataset detailed display screen displayed in the first user device.

FIG. 12 is a diagram illustrating an example of the search result dataset detail display screen displayed in the first user device.

FIG. 13 is a diagram illustrating an example of a matching selection screen displayed in a second user device.

FIG. 14 is a diagram illustrating an example of the matching selection screen displayed in the second user device.

FIG. 15 is a diagram illustrating an example of a matching result notification screen displayed in the first user device.

### DESCRIPTION OF EMBODIMENTS

Hereinafter, a mode for practicing the present invention (hereinafter referred to as an “embodiment”) will be described. Here, the description will be made in the following order.

1. Embodiment

2. Modification example

### 1. Embodiment

[Configuration Example of Information Processing System]

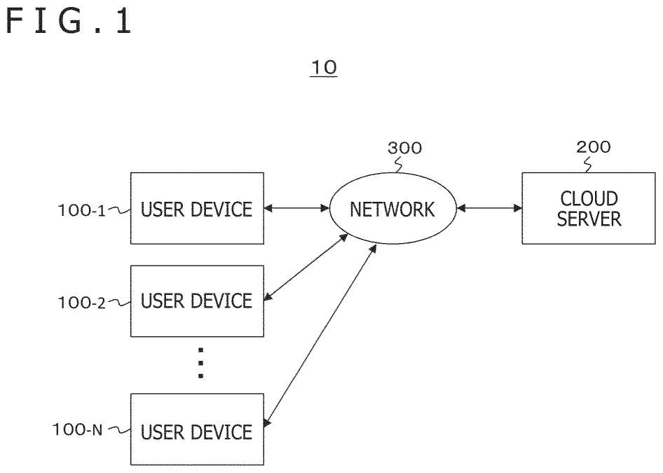

FIG. 1 illustrates a configuration example of an information processing system 10 as an embodiment. The information processing system 10 is configured such that a plurality of user devices 100-1 to 100-N is coupled to a cloud server 200 via a network 300 such as the Internet.

A user device 100 (each of the user devices 100-1 to 100-N) includes a classification executor (classification unit) configured by a neural network. This classification executor performs, for example, face recognition, animal recognition, or the like, from an image. The user device 100 uploads its own dataset for learning to the cloud server 200 via the network 300.

The cloud server 200 extracts a feature value of a first dataset having been uploaded from a first user device 100, to compare the extracted feature value with feature values of second datasets that are already uploaded from a predetermined number of other individual second user devices 100, and determines whether or not each of the predetermined number of second datasets is a dataset usable together with the first dataset, on the basis of the result of the comparison. This configuration makes it possible to facilitate obtaining of datasets that are usable together with the first dataset.

In this case, for example, lacking data information associated with the first dataset is referred to. This configuration makes it possible to determine that a second dataset having data that may complement lacking data in the first dataset is a dataset usable together with the first dataset.

Here, as main use cases, for example, the following two cases are possible.

Case 1: A case where data associated with an already owned label is intended to be further increased by being merged with another piece of data

Case 2: A case where data including data associated with an unowned label is intended to be acquired

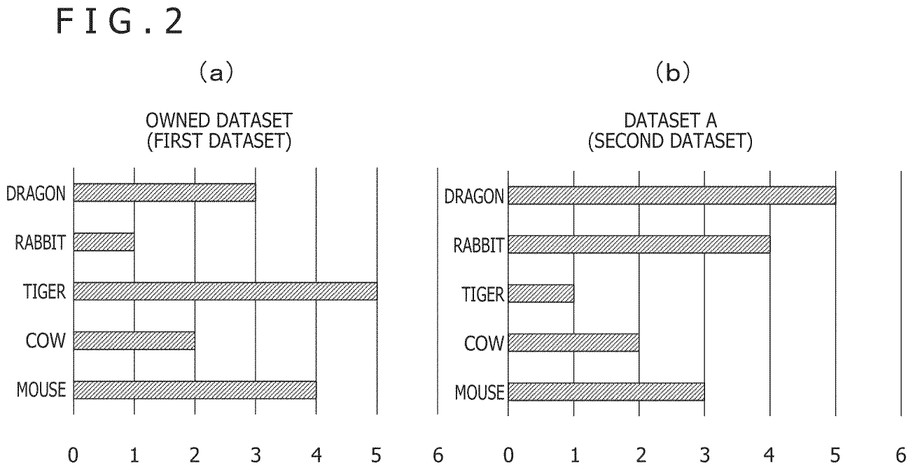

In the case of the case 1, all labels are specified in a “lacking data details” input field that is used when the first user device 100 uploads the first dataset. In this case, for example, when an owned dataset (first dataset) is a dataset corresponding to a label distribution such as that illustrated in FIG. 2(a), a dataset A (second dataset) corresponding to a label distribution such as that illustrated in FIG. 2(b) is determined to be a dataset usable together.

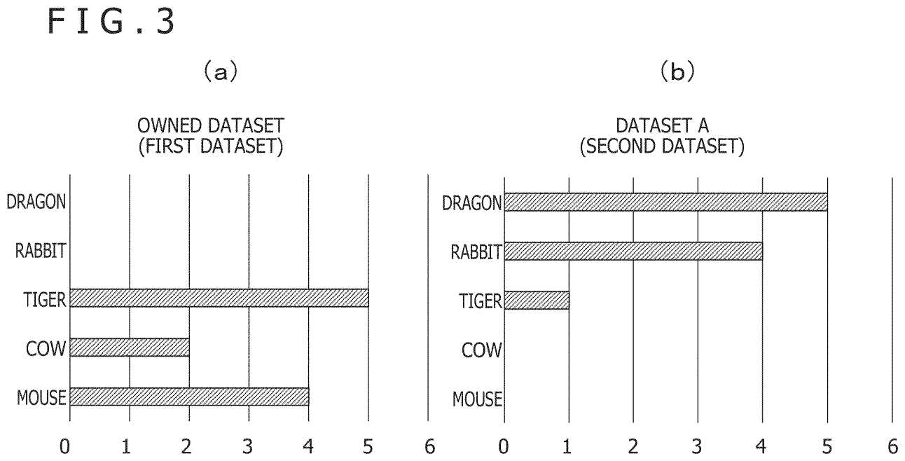

In the case of the case 2, unowned labels are specified in the “lacking data details” input field that is used when the first user device 100 uploads the first dataset. In this case, for example, when an owned dataset (first dataset) is a dataset corresponding to such a label distribution as that illustrated in FIG. 3(a), a dataset A (second dataset) corresponding to such a label distribution as that illustrated in FIG. 3(b) is determined to be the dataset usable together.

The cloud server 200 transmits and presents, to the first user device 100, information regarding second datasets having been determined to be datasets usable together with the first dataset. The first user device 100 selects a predetermined number of second datasets that are to be used together with the first dataset from among the predetermined number of presented second datasets, and applies for matching for the selected second datasets to the cloud server 200 via the network 300.

The cloud server 200 notifies a second user device 100 which has uploaded a second dataset for which the application for matching has been made of the receipt of the matching request. In response to this, the second user device 100 notifies the cloud server 200 of the approval or refusal of the matching via the network 300. The cloud server 200 notifies the first user device 100 of the approval or refusal of the matching. In the case where there is a second dataset for which matching has been refused, the first user device 100 can newly select another second dataset, and similar matching processing is also performed on the newly selected second dataset.

The cloud server 200 performs learning with a learning executor (learning unit) equipped in the cloud server 200, by using the first dataset and the predetermined number of second datasets having been requested for by the first user device 100 and having been obtained through the above matching processing, and transmits the result of the learning to the first user device 100 via the network 300. The first user device 100 uses the learning result transmitted from the cloud server 200, by setting the learning result into its own classification executer. Performing such learning based on the first dataset and the predetermined number of second datasets makes it possible to obtain a good-quality learning result, as compared with a case where learning is performed using only the first dataset.

In addition, although the configuration has been described above that learning is performed by the cloud server 200, another configuration in which the learning is performed by the first user device 100 is also possible. In such a case, the cloud server 200 transmits, to the first user device 100 via the network 300, a predetermined number of second datasets that have been selected by the first user device 100 and that have been approved. Then, the first user device 100 performs learning using the first dataset and the predetermined number of second datasets, and uses the result of the learning by setting the learning result in its own classification executor.

“Configuration of User Device”

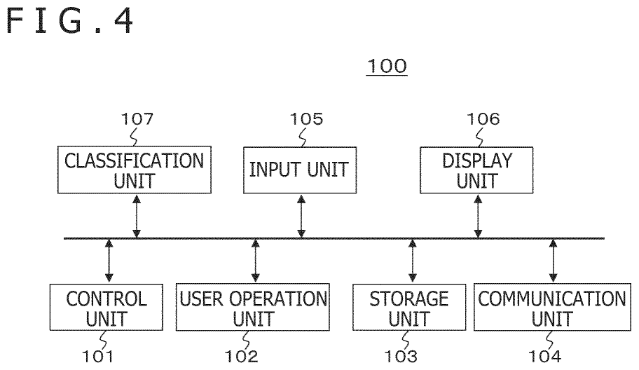

FIG. 4 illustrates a configuration example of the user device 100 (each of the user devices 100-1 to 100-N). The user device 100 includes a control unit 101, a user operation unit 102, a storage unit 103, a communication unit 104, an input unit 105, a display unit 106, and a classification unit (classification executor) 107.

The control unit 101 includes a CPU, a ROM, a RAM, and other components, and the CPU controls operations of individual portions of the user device 100 on the basis of a program stored in, for example, the ROM. The user operation unit 102 is a portion in which a user performs various operations. The input unit 105 includes a camera for acquiring image data, a microphone for acquiring speech data, and other components. The storage unit 103 stores therein the image data and the speech data that have been acquired by the input unit 105. Further, the storage unit 103 stores therein the dataset for learning (first dataset).

The communication unit 104 communicates with the cloud server 200. The communication unit 104 transmits the dataset for learning (first dataset) stored in the storage unit 103 and information regarding this dataset to the cloud server 200 via the network 300. Further, the communication unit 104 receives the learning result and presentation information regarding matching from the cloud server 200 via the network 300.

The classification unit 107 includes, for example, a neural network, and uses the learning result having been received by the communication unit 104 and having been set in the classification unit 107 itself. The display unit 106 constitutes a user interface, together with the user operation unit 102, and performs screen display operations in conjunction with various operations by the user device 100. Further, the display unit 106 also displays the result of classification made by the classification unit 107.

“Configuration of Cloud Server”

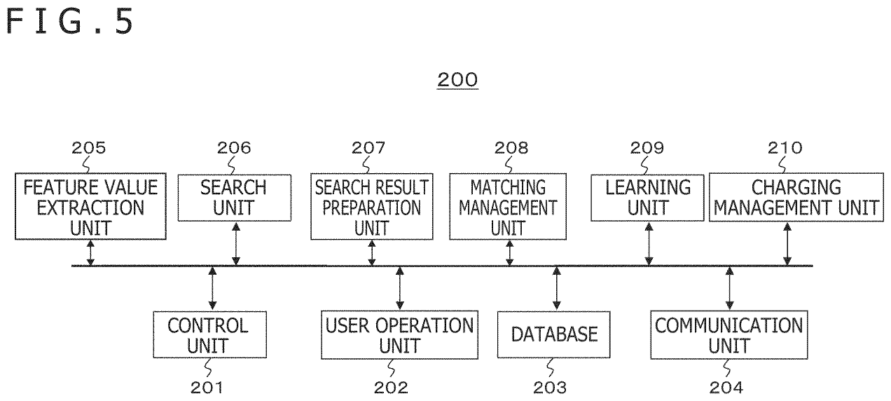

FIG. 5 illustrates a configuration example of the cloud server 200. The cloud server 200 includes a control unit 201, a user operation unit 202, a database 203, a communication unit 204, a search unit 206, a search result preparation unit 207, a matching management unit 208, a learning unit (learning executor) 209, and a charging management unit 210.

The control unit 201 includes a CPU, a ROM, a RAM, and other components, and the CPU controls operations of individual portions of the cloud server 200 on the basis of a program stored in, for example, the ROM. The user operation unit 202 is a portion in which a user performs various operations. The database 203 stores therein a dataset and information regarding this dataset which are transmitted from the user device 100 (each of the user devices 100-1 to 100-N). Further, the database 203 stores therein a feature value extracted by the feature value extraction unit 205 with respect to the dataset transmitted from the user device 100 (each of the user devices 100-1 to 100-N) in such a way that the feature value is associated with the dataset.

The communication unit 204 communicates with the user device 100. The communication unit 204 receives the dataset and the information regarding the dataset which are transmitted from the user device 100. Further, the communication unit 204 transmits, to the first user device 100, the learning result that the learning unit 209 has obtained by performing learning using the first dataset from the first user device 100 and the predetermined number of second datasets that have been selected by the first user device 100 and that have been approved.

The feature value extraction unit 205 extracts a feature value of a dataset transmitted from the user device 100. The search unit 206 compares the feature value of the first dataset having been uploaded from the first user device 100 with feature values of a predetermined number of second datasets that are already uploaded from other individual second user devices 100, to determine whether or not each of the predetermined number of second datasets is a dataset usable together with the first dataset, on the basis of the result of the comparison, and transmits the determination result to the control unit 201.

The search result preparation unit 207 prepares presentation information presenting information regarding a dataset usable together with the first dataset, on the basis of the determination result obtained by the search unit 206. This presentation information is transmitted from the communication unit 204 to the first user device 100.

In the case where the application for matching from the first user device 100 has been received, the matching management unit 208 manages this matching. In this case, the matching management unit 208 notifies a second user device 100 which has uploaded the second dataset for which the application for matching has been made of the receipt of the matching request, receives a notification of the approval or refusal of the matching from the second user device 100, and transmits the content of the notification to the first user device 100.

The learning unit 209 performs learning using the first dataset from the first user device 100 and the predetermined number of second datasets that have been selected by the first user device 100 and that have been approved. As described above, the result of the learning is transmitted from the communication unit 204 to the first user device 100. In this case, a neural network used in the learning unit 209 is configured so as to correspond to the neural network that configures the classification unit 107 of the first user device 100. In this case, a neural network definition file used in the learning unit 209 may be uploaded in advance from the first user device 100.

The charging management unit 210 manages charging on the user device 100 connected to the cloud server 200.

“Outline of Processing of Information Processing System”

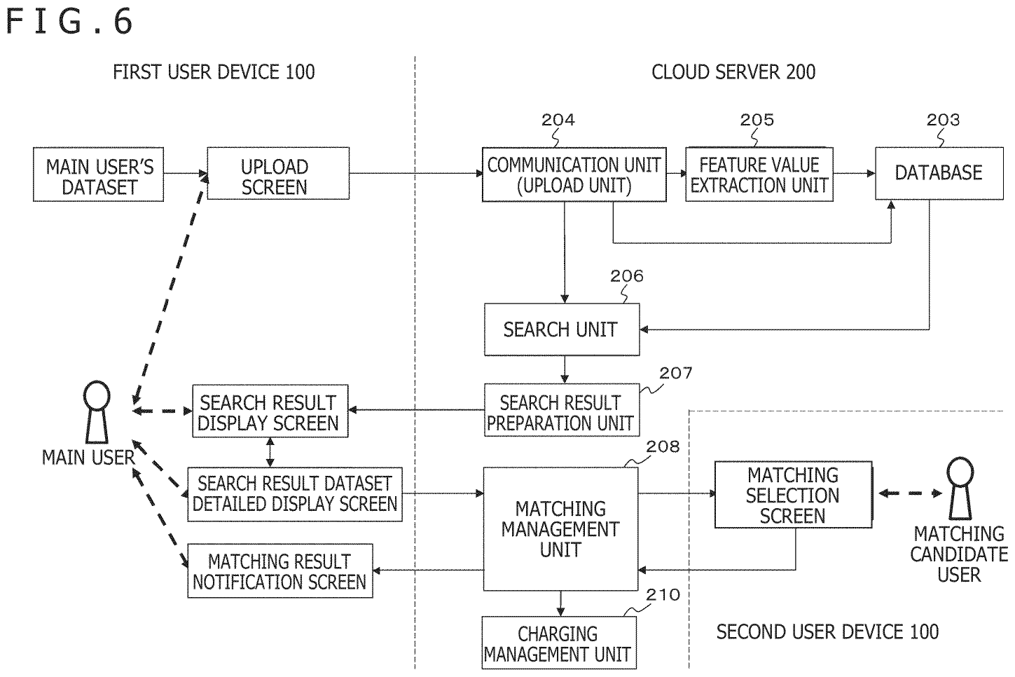

FIG. 6 illustrates the outline of processing in the information processing system 10 illustrated in FIG. 1. Note that a post-matching processing portion is omitted. In FIG. 6, portions corresponding to portions of FIGS. 1 and 5 are denoted by the same reference signs as those of the portions of FIGS. 1 and 5. In the illustrated example, the user of a first user device 100 corresponds to a “main user,” and the user of a second user device 100 corresponds to a “matching candidate user.”

When a first dataset (dataset of the main user) is uploaded from the first user device 100 to the cloud server 200, the main user performs this upload using an upload screen.

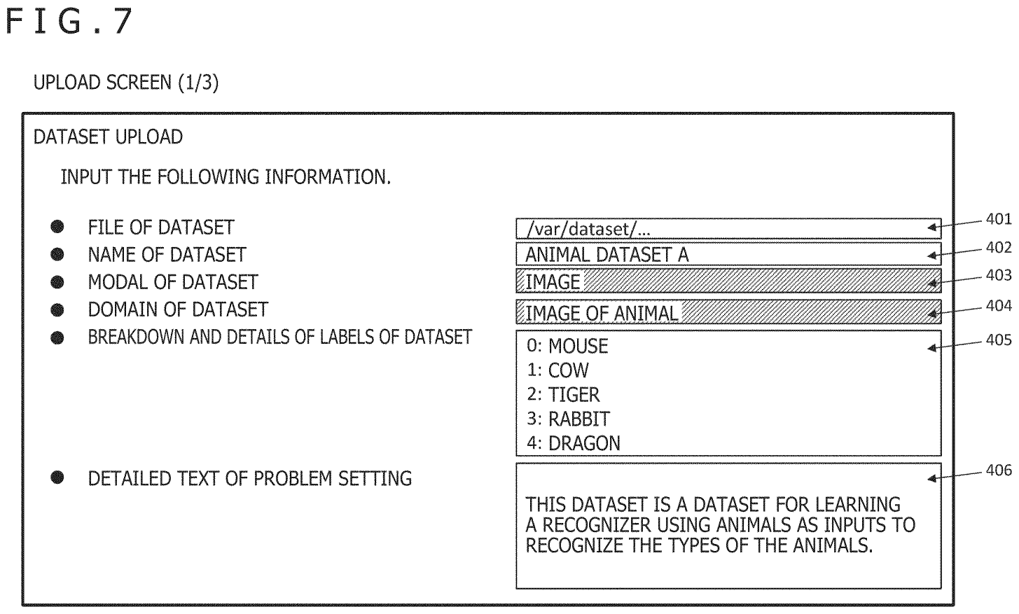

FIGS. 7, 8, and 9 illustrate an example of the upload screen. The upload screen includes a dataset file input field 401, a dataset name input field 402, a dataset modal input field 403, a dataset domain input field 404, a dataset label breakdown and details input field 405, and a problem setting detailed text input field 406 (see FIG. 7). Here, a label that does not exist in a dataset to be uploaded can also be input to the dataset label breakdown and details input field 405. Further, a text as to what kind of problem the dataset is used for the solution thereof can freely be input to the problem setting detailed text input field 406.

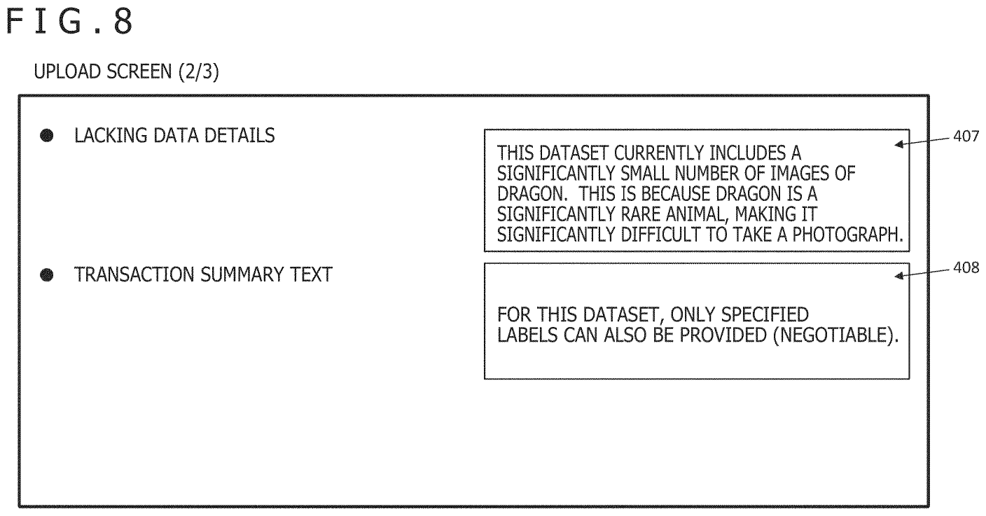

Further, the upload screen includes a lacking data details input field 407 and a transaction summary text input field 408 (see FIG. 8). A label for which data does not yet exist in the dataset and a label for which more data is desired are written into the lacking data details input field 107. Further, a detailed description regarding a transaction, such as a description as to by what kind of contract the dataset can be provided at the time of providing the dataset, is written into the transaction summary text input field 408. For example, selling by weight (a pay-as-you-go based contract according to the total number of pieces of data having been dealt with), a decision after negotiation, or the like is written thereinto. Further, for example, when an image and a label are treated as a set, such a description that only an image can be provided, only a label can be provided, or the like is written thereinto.

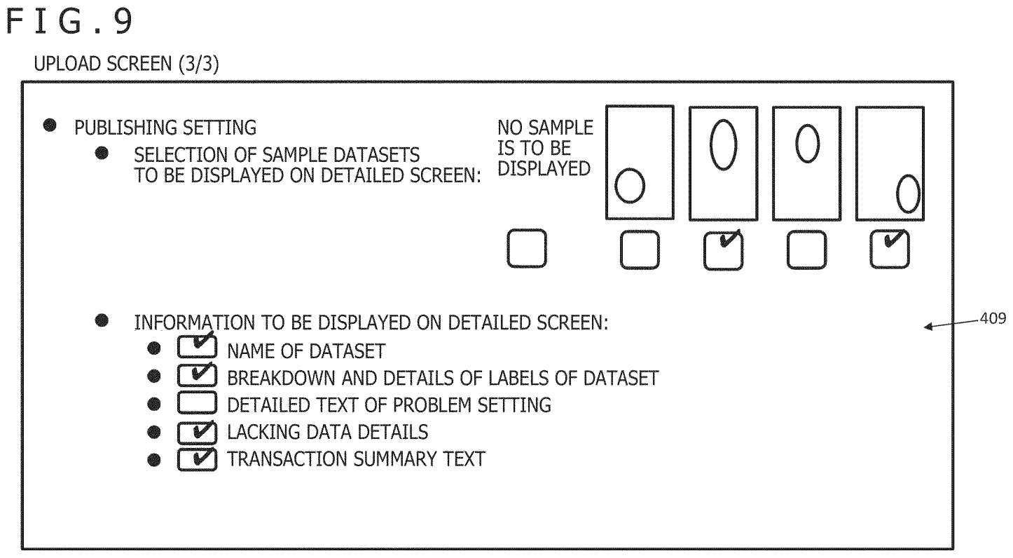

Further, the upload screen includes a publishing setting input field 409 (see FIG. 9). In the publishing setting input field 409, the selection of dataset samples to be displayed on the detailed screen is made. Further, in the publishing setting field 409, a setting is made to specify what kind of information is to be displayed among the kinds of information having been input on the upload screen. In the illustrated example, a setting is made to specify the display of the name of the dataset, the breakdown and details of labels of the dataset, the details of lacking data, and the summary text regarding the transaction.

The modal and the domain on the upload screen are information that can be estimated from uploaded data, and thus a method in which the modal and the domain are automatically complemented on the upload screen is possible. In this case, possible is a method in which input fields in which contents have been automatically estimated are displayed so as to be differentiated from other input fields by coloring the first-mentioned input fields, or in any other similar way (in the illustrated example, such input fields being illustrated with hatching lines). Further, it takes a long time to upload the dataset, and thus, a method in which, during a period until the completion of the upload, by making the above estimation using only partial data, the input of the information regarding the dataset is enabled is possible.

The modal and the domain of a dataset will be described below. The modal means a form of relevant data, and its examples include an “image,” a “speech,” and the like. The domain means a class being finer than the modal and further expressing the content of relevant data, and its examples regarding an image include an “image of a face,” an “image of a finger script,” and the like.

Examples of the modal and the domain will be given below.
Modal
   Image, speech, document, etc.
Domain
   Image
      Face, wear, fingerprint, etc.
      Its class is determined by a system, or can newly be registered by a user.
   Advertisement
      What kind of advertisement
   Speech
      Greetings
      General noun
      Specific words such as startup words
   Document
      Novel
      Advertisement
      E-mail
      In-house document

The communication unit 204 of the cloud server 200 receives all pieces of data that are transmitted from the first user device 100 using the upload screen, and transfers them to the database 203. Further, the communication unit 204 transfers, to the feature value extraction unit 205, the file of the dataset, the detailed text of the dataset, the detailed text regarding the problem setting, and the details of the lacking data.

In order to bring the uploaded dataset into a searchable state, a mechanism which deals with, in a uniformed manner, the dataset including a huge number of pieces of data having mutual differences in form and the like is necessary. As one of methods for dealing with such a dataset in a uniformed manner, possible is a method which extracts, from the dataset, a feature value that is information having a specific type and serving like a summary of information of the entire dataset. The feature value extraction unit 205 processes the uploaded dataset, for such purpose and in such manner.

As a use case 1, the feature value extraction unit 205 extracts an average or a standard deviation regarding aggregates of predetermined elements of output and intermediate layers in the learned neural network at times when individual sets of data constituting the dataset are input to the learned neural network.

An execution example in an image modal will be described below.

1. An image recognition executor configured by a preliminarily learned neural network (NN) is prepared.

2. For individual sets of data constituting the dataset, at times when the individual sets of data are input to the neural network, averages and standard deviations are calculated with respect to aggregates of predetermined elements of output and the intermediate layers.

3. An average and a standard deviation regarding the averages and the standard deviations for the individual sets of data are calculated, and these values are stored as a feature value of the dataset.

Further, as a use case 2, in the case where individual sets of data constituting the dataset have labels of classes, the feature value extraction unit 205 extracts a distribution regarding the labels as a feature value.

An execution example in the image modal will be described below.

1. All labels that may exist as labels of the classes of an image are specified in advance. For example, labels obtained by merging the labels of all uploaded datasets are used.

2. Frequencies of data in the individual classes are expressed by a vector, and this vector is treated as a feature value.

The database 203 stores therein all pieces of data transmitted from the first user device 100 using the upload screen. Further, the feature value extraction unit 205 stores therein extracted feature values.

The search unit 206 compares a feature value of a first dataset having been uploaded from a first user device 100 with feature values of a predetermined number of second datasets that are already uploaded from other individual second user devices 100, to determine whether or not each of the predetermined number of second datasets is a dataset usable together with the first dataset (namely, a conforming dataset), on the basis of the result of the comparison.

Specifically, the search unit 206 performs the following operations.

1. With respect to a distribution regarding labels of the uploaded first dataset, an originally desired, optimal distribution regarding the labels is calculated on the basis of the details of lacking data.

2. For each of a predetermined number of second datasets having feature values that are presented in a feature value calculation unit 2015 and are close to the feature value of the first dataset, an inter-distribution distance between a distribution regarding labels of each of the predetermined number of second datasets and the optimal distribution regarding the labels of the first dataset is calculated as a conformity score.

3. Among the predetermined number of second datasets for each of which the conformity score has been calculated, datasets each having a conformity score higher than a preliminarily specified threshold value are determined to be conforming datasets, that is, datasets usable together with the first dataset.

The search result preparation unit 207 prepares presentation information presenting information regarding the datasets usable together with the first dataset, i.e., search result display screen information, on the basis of the determination result obtained by the search unit 206. In this case, the content of the display is changed according to the publishing setting having been input on the upload screen. The presentation information having been prepared by the search result preparation unit 207 in such way is transmitted to the first user device 100.

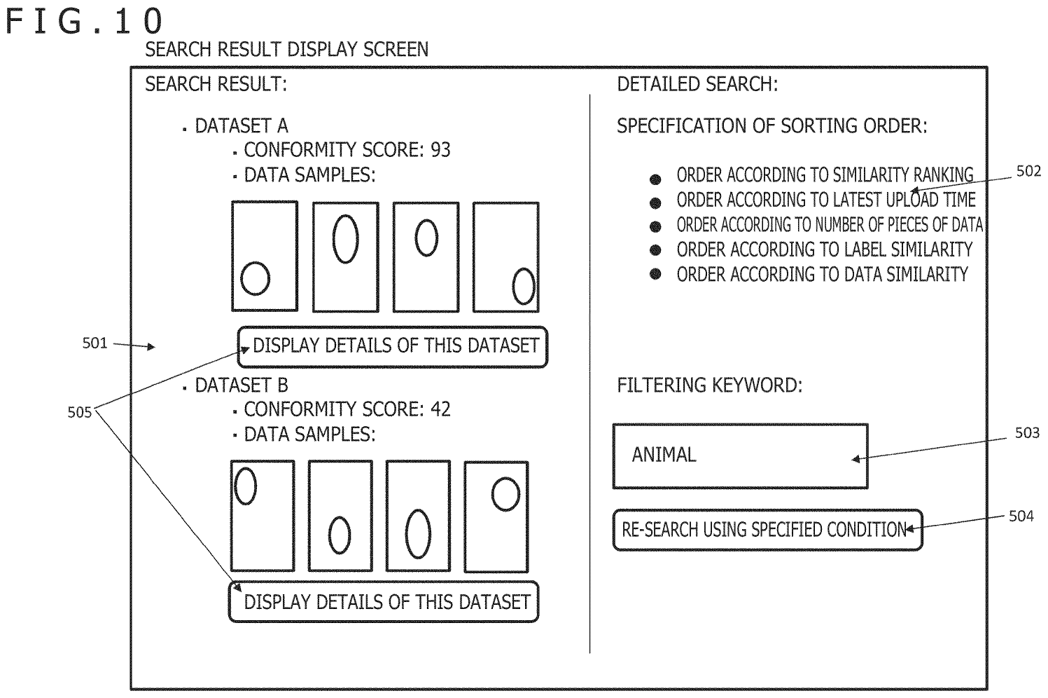

The first user device 100 displays the search result display screen on the basis of the presentation information. FIG. 10 illustrates an example of the search result display screen. This search result display screen includes a list section 501 for information regarding the second datasets usable together with the owned dataset (first dataset). In the illustrated example, two second datasets are displayed. Further, as information regarding each of the second datasets, a dataset name, a conformity score, and thumbnails as data samples are displayed.

Further, the search result display screen includes a button 502 for specifying a sorting order in which each of the second datasets is to be sorted. In this case, any change can be made among an order according to a similarity ranking (an order according to a conformity score), an order according to latest upload time, an order according to the number of pieces of data, an order according to label similarity, an order according to data similarity, and the like. Further, the search result display screen includes a filtering keyword text input field 503 for use in filtering the second datasets to be displayed. Further, the search result display screen includes a button 504 for use in making a re-search in a specified sorting order or by using a filtering keyword having been input. Further, the search result display screen includes a button 505 that corresponds to information regarding each of the second datasets and that is used for performing detailed display of each second dataset.

Note that the search result display screen illustrated in FIG. 10 is a mere example, and another example in which a partial display portion in the illustrated example is omitted is possible.

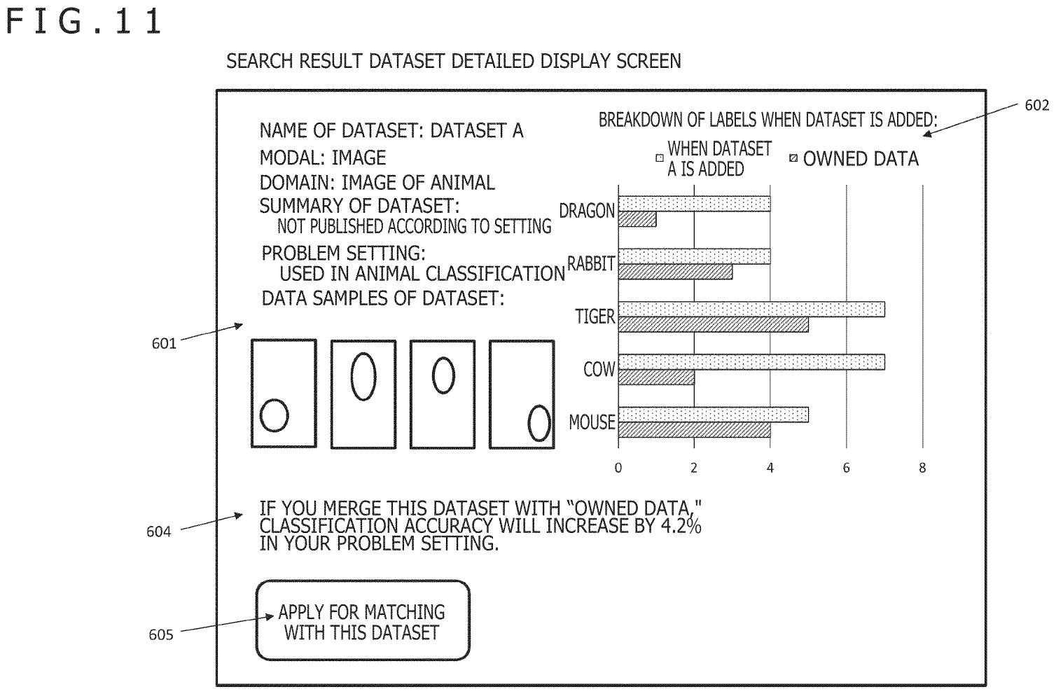

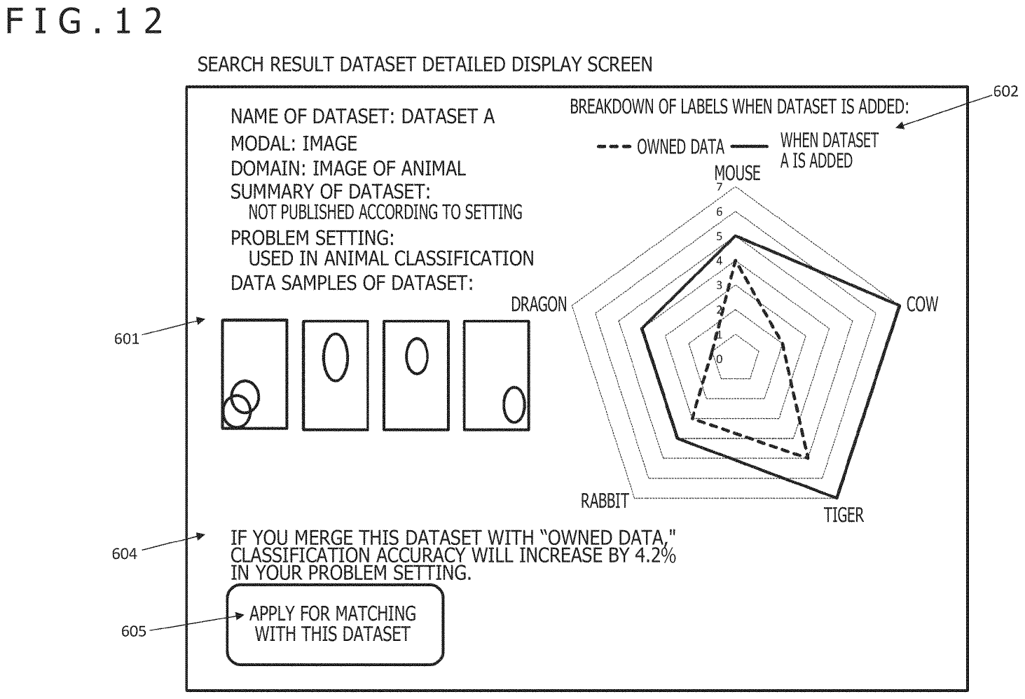

FIGS. 11 and 12 illustrate examples of the search result dataset detailed display screen. The illustrated examples are examples in the case where the button 505 corresponding to a dataset A in FIG. 10 has been operated.

The search result dataset detailed display screen displays information 601 having been input on the upload screen, according to the publishing setting. Further, the search result dataset detailed display screen displays a breakdown 602 of labels of the dataset. In this case, a breakdown of the owned dataset and a breakdown of a dataset obtained by adding a dataset that is a target of this detailed display (namely, the dataset A in the illustrated example) to the owned dataset are displayed. In this case, examples of a possible display method include a display using a bar graph (see FIG. 11), a display using a radar chart (see FIG. 12), and the like.

Further, the search result dataset detailed display screen includes a button 603 for use in applying for matching. A user of the first user device 100 (namely, a main user) can apply for matching with the dataset that is a target of this detailed display (namely, the dataset A in the illustrated example) by operating the button 603, and information regarding the application for matching is transmitted to the cloud server 200.

Further, the search result dataset detailed display screen displays improvement information 604 indicating classification accuracy improvement obtained by using the dataset resulting from adding (merging) the dataset that is a target of this detailed display (namely, the dataset A in the illustrated example) to (with) the owned dataset.

In this case, the cloud server 200 calculates an identification ratio or the like by using the uploaded dataset (the first dataset). Further, the cloud server 200 predicts, in some method, to what degree the classification accuracy is improved when the dataset is added. For example, by plotting an estimation index, such as an identification ratio, at the time of sequentially increasing data in the dataset to be added, the cloud server 200 obtains the degree of the improvement of performance at the time of merging the data. This method makes it possible for the search result preparation unit 207 of the cloud server 200 to include classification accuracy improvement information in the presentation information.

Note that the search result display screen illustrated in each of FIGS. 11 and 12 is a mere example, and another example in which a partial display portion of the illustrated example is omitted is possible.

Referring back to FIG. 6, the matching management unit 208 of the cloud server 200 performs the following kinds of processing necessary for implementing a matching function.

1. Processing for, upon receipt of application for matching with a second dataset from the first user device 100, giving a notification of the application for matching to a user (matching candidate user) of a second user device 100 corresponding to the second dataset, through a matching selection screen.

2. Processing for, in the case where the user of the second user device 100 has selected the approval or refusal of the application for matching, giving a notification of the result of the matching to a user (main user) of the first user device 100 through a matching result notification screen.

3. Processing for, when the application for matching has been approved, requesting the charging management unit 210 to perform charging for each associated user according to a preliminarily determined condition.

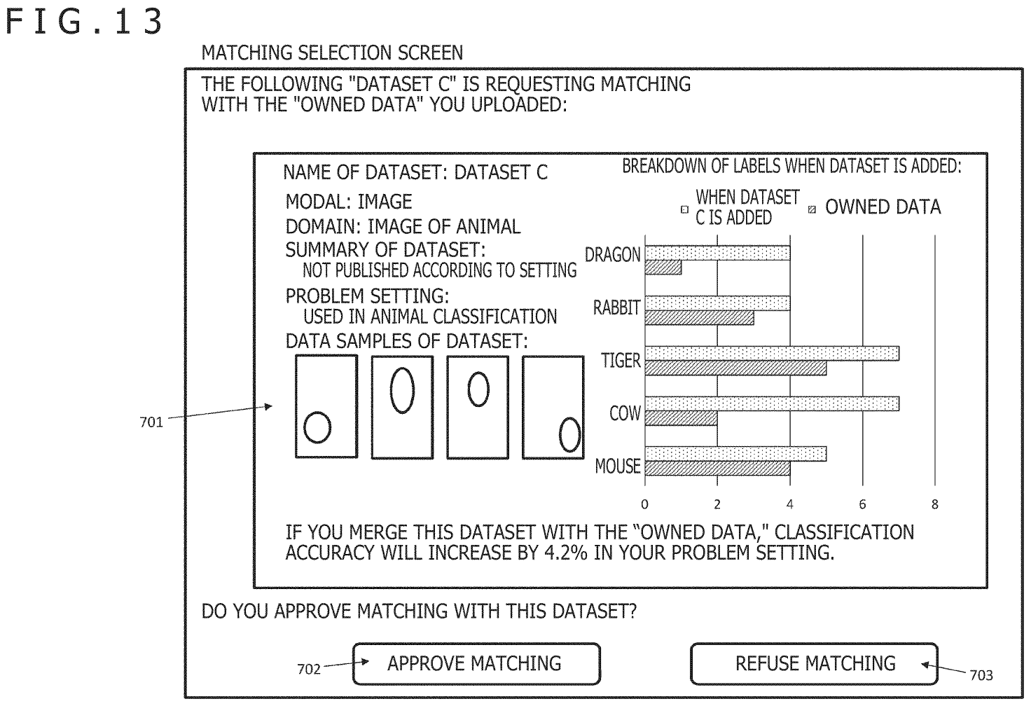

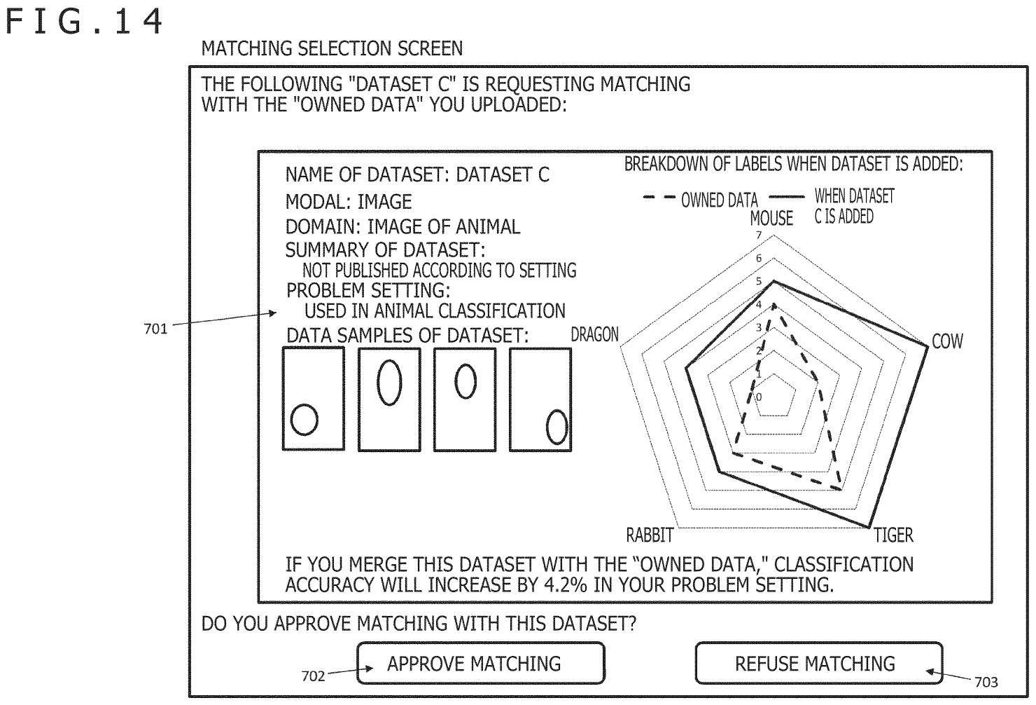

FIGS. 13 and 14 illustrate examples of the matching selection screen. The presentation information on the matching selection screen is generated by the matching management unit 208 and is then transmitted to the second user device 100. The matching selection screen displays details 701 of a dataset (first dataset) of an applying source of the application for matching in the same form as that of the above search result dataset detailed display screen. Further, the presentation information on the matching selection screen includes a button 702 for use in approving the matching and a button 703 for use in refusing the matching.

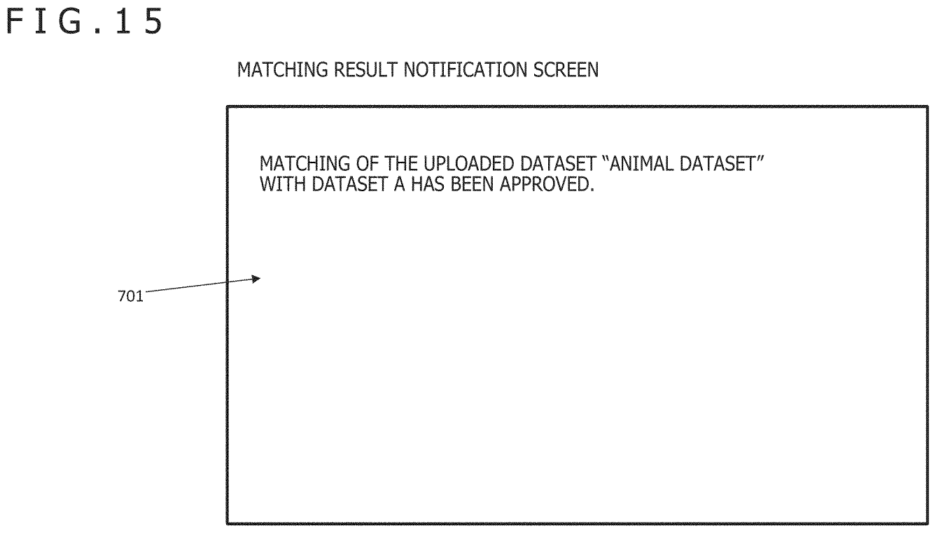

FIG. 15 illustrates an example of the matching result notification screen. This matching result notification screen includes a text 801 for giving a notification of the approval or refusal of the matching of the dataset having been uploaded by oneself (namely, the first dataset) with the dataset for which the application for matching has been requested by oneself (namely, the second dataset). The illustrated example is an example of the notification of the approval.

Referring back to FIG. 6, the charging management unit 210 manages charging for the user devices 100 connected to the cloud server 200. Examples of a possible charging timing include the following timings.

1. Pay-as-you-go based charging is performed according to the number of searches.

2. Pay-as-you-go based charging is performed according to the number of matching applications.

3. While the summary screen is displayed, company information is kept secret, and for every display of a detailed screen, company information regarding the other party is displayed and charging is performed (that is, pay-as-you-go based charging is performed according to the number of views of the detailed screen). This method is employed to prevent a situation in which only contact information is acquired and a transaction is made outside a service.

As described above, the user of the first user device 100 (namely, the main user) is able to select a dataset to be used together with the owned dataset (first dataset) from among a predetermined number of datasets (second datasets) list-displayed on the search result display screen (see FIG. 10), and to apply for matching through the search result dataset detailed display screen (see FIG. 11 and FIG. 12) associated with the selected dataset.

This method enables the user of the first user device 100 (namely, the main user) to, subsequent to the approval by a user of a second user device 100 (namely, a matching candidate user) who has uploaded the dataset (second dataset) associated with the application for matching, obtain the dataset (second dataset) as the dataset to be used together with the main user's own dataset (first dataset). The user of the first user device 100 (namely, the main user) is able to obtain a plurality of the datasets (second datasets) to be used together with the dataset (first dataset) by repeating the above-described operation.

Here, although, in the above method, such matching processing is needed, another method which enables the user of the first user device 100 (namely, the main user) to, merely by selecting a dataset (second dataset) to be used together with the main user's own dataset (first dataset) from among the predetermined number of datasets (second datasets) list-displayed on the search result display screen (see FIG. 10), obtain the selected dataset as the dataset to be used together with the owned dataset (first dataset) is possible. In this case, it is deemed that, at the time of uploading the second dataset to the cloud server 200, the user of the second user device 100 has already approved the matching on the assumption that, for example, a condition such as a consideration payment to the user or the like is to be approved.

In the information processing system 10 illustrated in FIG. 1, in the cloud server 200, the learning unit 209 (see FIG. 5) learns about a first user device 100 (see FIG. 6) by using a first dataset and a predetermined number of second datasets having been obtained by the first user device 100. Further, the result of the learning is transmitted from the cloud server 200 to the first user device 100 via the network 300. In the first user device 100, the learning result transmitted from the cloud server 200 is used by being set in a classification unit of the first user device 100 (see FIG. 4).

As described above, in the information processing system 10 illustrated in FIG. 1, in the cloud server 200, the feature value of the first dataset is compared with the feature values of the predetermined number of second datasets, and a determination as to whether or not each of the predetermined number of second datasets is a dataset usable together with the first dataset is made on the basis of the result of the comparison. This configuration, therefore, makes it possible to facilitate obtaining of the dataset usable together with the first dataset.

Further, in the information processing system 10 illustrated in FIG. 1, the first user device 100 that has uploaded the first dataset to the cloud server 200 is capable of displaying the search result display screen on the basis of the presentation information transmitted from the cloud server 200. Thus, a user having the first dataset is able to receive the presentation of information regarding second datasets having been determined to be datasets usable together with the first dataset, and is thus able to easily obtain desired second datasets as datasets usable together with the first dataset.

Note that the effects described in the present description are mere examples and do not limit the effects of the present invention, which may have additional effects.

### 2. Modification Example

Note that, in the above-described embodiment, information regarding each of the predetermined number of second datasets that are simultaneously usable together with the first dataset is displayed in a specified sorting order on the search result display screen (see FIG. 10) displayed in the first user device 100. In this case, it is possible to employ another configuration in which, among the predetermined number of second datasets, a second dataset with its display to be performed with high priority under a contract of a prior consideration payment is displayed at a top position regardless of the specified sorting order. Further, in this case, it is possible to employ still another configuration in which the second dataset with its display to be performed with high priority under a contract is displayed as an advertisement at a particular position apart from the list on the search result display screen (see FIG. 10) so as to be selected by the user (main user) of the first user device 100.

Further, the preferred embodiment of the present disclosure has been described in detail referring to the accompanying drawings, but the technical scope of the present disclosure is not limited to such an example. It is obvious that any person having ordinary knowledge in the technical field of the present disclosure is able to conceive of various changes or modifications within the scope of the technical ideas described in the claims, and naturally, these changes and modifications are also deemed to belong to the technical scope of the present disclosure.

Further, the present technology can also have the following configurations.

(1)

An information processing device including:

a control unit that controls comparison processing for comparing a feature value of a first dataset with feature values of a predetermined number of second datasets and determination processing for determining whether or not each of the predetermined number of second datasets is a dataset usable together with the first dataset on the basis of a result of the comparison.

(2)

The information processing device according to (1), in which a feature value of each of the first dataset and the second datasets is an average or a standard deviation regarding aggregates of predetermined elements of output and intermediate layers in a learned neural network at times when individual sets of data constituting the dataset are input to the leaned neural network.

(3)

The information processing device according to (1) or (2), in which a feature value of each of the first dataset and the second datasets is, in a case where each of sets of data constituting the dataset has a label of a corresponding one of classes, a distribution of total numbers of data in the individual classes.

(4)

The information processing device according to any one of (1) to (3), in which, in the determination processing, lacking data information associated with the first dataset is referred to.

(5)

The information processing device according to any one of (1) to (4), in which the control unit further controls presentation processing for presenting information regarding each of second datasets that is included in the predetermined number of second datasets and that has been determined to be the dataset usable together with the first dataset.

(6)

The information processing device according to (5), in which the information regarding each of the second datasets includes information regarding a dataset name used for dataset identification.

(7)

The information processing device according to (5) or (6), in which the information regarding each of the second datasets includes information regarding a conformity score indicating conformity with the first dataset.

(8)

The information processing device according to any one of (5) to (7), in which the information regarding each of the second datasets includes information regarding sample data.

(9)

The information processing device according to any one of (5) to (8), in which the presentation processing further presents a sorting order specification region for use in specifying in which order the information regarding each of the second datasets that has been determined to be the dataset usable together with the first dataset is to be presented.

(10)

The information processing device according to any one of (5) to (9), in which the presentation processing further presents a filtering information input region for use in inputting information for filtering one or more to-be-presented second datasets from the second datasets that have each been determined to be the dataset usable together with the first dataset.

(11)

The information processing device according to any one of (5) to (10), in which the presentation processing further presents an operation region associated with each of the second datasets to be presented and used for an operation that causes a detailed display of each of the second datasets to be presented to be performed.

(12)

An information processing method including:

a procedure of comparing a feature value of a first dataset with feature values of a predetermined number of second datasets; and

a procedure of determining whether or not each of the predetermined number of second datasets is a dataset usable together with the first dataset on the basis of a result of the comparison.

(13)

A program that causes a computer to function as:

comparison means that compares a feature value of a first dataset with feature values of a predetermined number of second datasets; and

determination means that determines whether or not each of the predetermined number of second datasets is a dataset usable together with the first dataset on the basis of a result of the comparison.

### REFERENCE SIGNS LIST

10: Information processing system
100, 100-1 to 100-N: User device
101: Control unit
102: User operation unit
103: Storage unit
104: Communication unit
105: Input unit
107: Classification unit
108: Display unit
200: Cloud server
201: Control unit
202: User operation unit
203: Database
204: Communication unit
205: Feature value extraction unit
206: Search unit
207: Search result preparation unit
208: Matching management unit
209: Learning unit
210: Charging management unit
300: Network

1. An information processing device comprising:
a control unit that controls comparison processing for comparing a feature value of a first dataset with feature values of a predetermined number of second datasets and determination processing for determining whether or not each of the predetermined number of second datasets is a dataset usable together with the first dataset on a basis of a result of the comparison.

2. The information processing device according to claim 1, wherein a feature value of each of the first dataset and the second datasets is an average or a standard deviation regarding aggregates of predetermined elements of output and intermediate layers in a learned neural network at times when individual sets of data constituting the dataset are input to the leaned neural network.

3. The information processing device according to claim 1, wherein a feature value of each of the first dataset and the second datasets is, in a case where each of sets of data constituting the dataset has a label of a corresponding one of classes, a distribution of total numbers of data in the individual classes.

4. The information processing device according to claim 1, wherein, in the determination processing, lacking data information associated with the first dataset is referred to.

5. The information processing device according to claim 1, wherein the control unit further controls presentation processing for presenting information regarding each of second datasets that is included in the predetermined number of second datasets and that has been determined to be the dataset usable together with the first dataset.

6. The information processing device according to claim 5, wherein the information regarding each of the second datasets includes information regarding a dataset name used for dataset identification.

7. The information processing device according to claim 5, wherein the information regarding each of the second datasets includes information regarding a conformity score indicating conformity with the first dataset.

8. The information processing device according to claim 5, wherein the information regarding each of the second datasets includes information regarding sample data.

9. The information processing device according to claim 5, wherein the presentation processing further presents a sorting order specification region for use in specifying in which order the information regarding the each of the second datasets that has been determined to be the dataset usable together with the first dataset is to be presented.

10. The information processing device according to claim 5, wherein the presentation processing further presents a filtering information input region for use in inputting information for filtering one or more to-be-presented second datasets from the second datasets that have each been determined to be the dataset usable together with the first dataset.

11. The information processing device according to claim 5, wherein the presentation processing further presents an operation region associated with each of the second datasets to be presented and used for an operation that causes a detailed display of each of the second datasets to be presented to be performed.

12. An information processing method comprising:
a procedure of comparing a feature value of a first dataset with feature values of a predetermined number of second datasets; and
a procedure of determining whether or not each of the predetermined number of second datasets is a dataset usable together with the first dataset on a basis of a result of the comparison.

13. A program that causes a computer to function as:
comparison means that compares a feature value of a first dataset with feature values of a predetermined number of second datasets; and
determination means that determines whether or not each of the predetermined number of second datasets is a dataset usable together with the first dataset on a basis of a result of the comparison.
